(19) United States
(12) Patent Application Publication
(10) Pub. No.: US 2012/0243027 A1
(43) Pub. Date: Sep. 27, 2012

(54) Print Job Progress Display Mechanism

(76) Inventors: Marquis G. Waller, Beverly, OH (US); Linda S. Liebelt, Boulder, CO (US); Diane L. Wightman McKee, Longmont, CO (US); William A. Roach, III, Longmont, CO (US)

(21) Appl. No.: 13/053,734

(22) Filed: Mar. 22, 2011

(51) Int. Cl. G06K 15/02

(52) U.S. Cl. 358/1.15

(57) ABSTRACT

A method disclosed. The method includes initiating the printing of a print job data at a printer, displaying a graphics indication within a graphical user interface (GUI) of a printing progress of the print job while the print job is printing, detecting that a spacing operation has been performed on the print job and updating the printing progress of the print job at the graphics indication based on the spacing operation that has been performed.

### FIELD OF THE INVENTION

The invention relates to the field of computer systems, and in particular, to upgrading printing software products.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is implemented at a print server to manage a print job from order entry and management through the complete printing process. The printing software often includes a graphical user interface (GUI) that enables users to control the printing process. The GUI often includes a graphic print job status feature (or progress bar) that provides a visual status of a print job while printing. Particularly, the progress bar provides a number of pages remaining to be printed in comparison with the total number of pages in the print job.

However, whenever backspace or forward space operations are performed on a job that is printing, the progress bar is not updated. If the progress bar is not updated, inaccurate print progress results occur. For example, a job that was 95% completed before being backspaced may appear as 150% completed after the job was restarted sometime previously. This lack of accuracy makes conventional progress bars unreliable.

Accordingly, a mechanism to provide an accurate print job progress bar is desired.

### SUMMARY

In one embodiment, a method includes initiating the printing of a print job data at a printer, displaying a graphics indication within a GUI of a printing progress of the print job while the print job is printing, detecting that a spacing operation has been performed on the print job and updating the printing progress of the print job at the graphics indication based on the spacing operation that has been performed

Another embodiment discloses a print server including a processor and a printing software product executed by the processor. The printing software product includes a GUI and initiates the printing of a print job data at a printer, displays a graphics indication within the GUI of a printing progress of the print job while the print job is printing, detects that a spacing operation has been performed on the print job and updates the printing progress of the print job at the graphics indication based on the spacing operation that has been performed.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates a screen shot of one embodiment of a printing software product;

FIG. 3 is a flow diagram illustrating one embodiment for providing a print job progress bar; and

FIG. 4 illustrates one embodiment of a computer system.

### DETAILED DESCRIPTION

A mechanism to provide an accurate print job progress bar is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

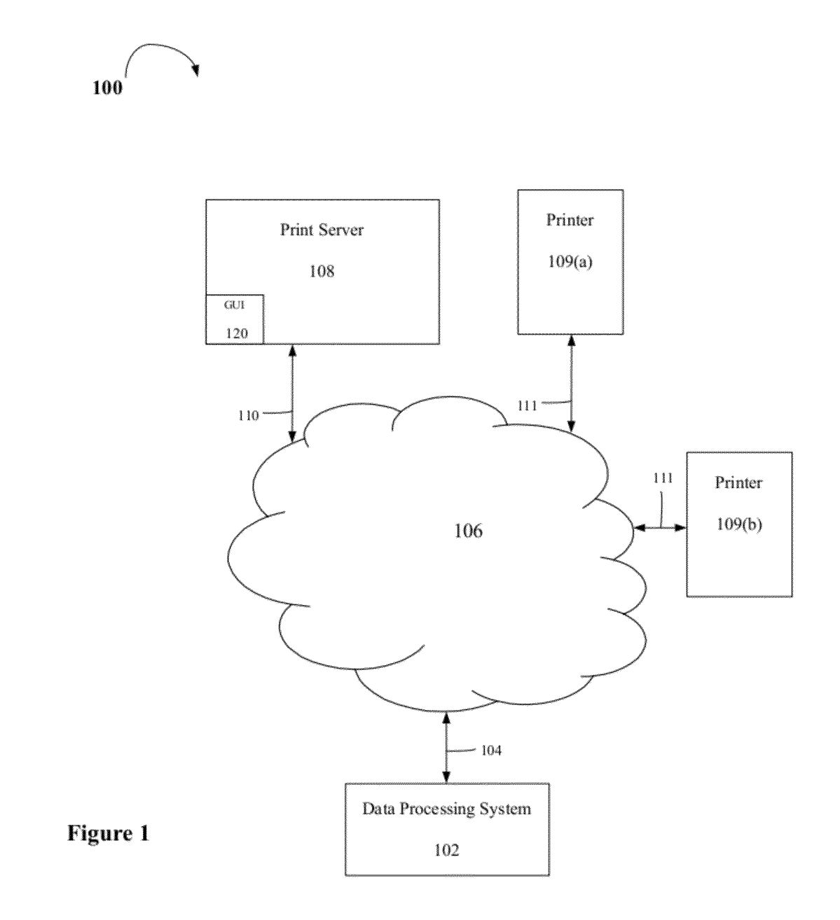

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110. Print server 108 subsequently transmits the print requests via communications link 110 to one of printers 109 for printing, which are coupled to network 106 via communications links 111. In one embodiment, an operator at data processing system 102 may interact with print server 108 using a GUI 120 to submit requests for service requests to printer 109 over network 106. In a further embodiment, print server 108 includes a print queue for print jobs requested by remote data processing systems.

Although described as separate entities, other embodiments may include print server 108 being incorporated in one or more of the printers 109. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 to one or more of printers 109. In other embodiments, the printing software manages printing of documents from multiple data processing systems 102 to printers 109.

According to one embodiment, the printing software product may be implemented using either InfoPrint Manager (IPM) or InfoPrint ProcessDirector (IPPD), although other types of printing software may be used instead. In a further embodiment, the print printing software product includes GUI 120 that enables a system administrator (or operator) to interact with the print printing software product at printer server 108.

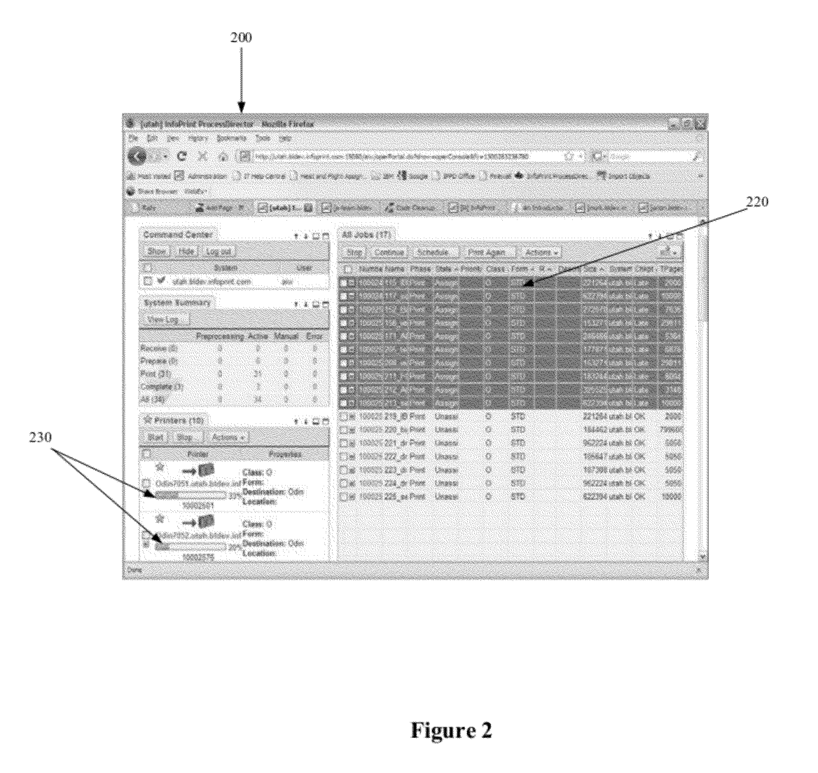

In a further embodiment, an operator at data processing system 102 implements GUI 120 to automatically submit print jobs to the printing software product. In still a further embodiment, GUI 120 includes a graphic print job progress bar that provides a visual status of a print job while printing. FIG. 2 is a screen shot 200 illustrating one embodiment of a GUI 120.

GUI 120 includes a list 220 of print jobs to be printed, as well as progress bars 230. Progress bars 230 each provide a graphic bar that represents a total number of pages in a print job. Additionally, each bar includes a shaded portion that indicates a proportionate percentage of the job that has been completed. A numerical percentage is indicated next to the bar as a further indication.

As discussed above, spacing (e.g., backspace or forward space operations) performed in conventional printing software products affect the accuracy of bars 230. In a large print job having in excess of 25,000 pages, it may sometimes be necessary to go back (e.g., backspace) to reprint pages that have already been printed due to print quality issues. For example, while page 15,000 of a print job is printing it may be discovered that problems with the printer ink began occurring at page 1,000. Thus, an operator may use GUI 120 to access the printing software product in order to begin printing again from page 1,000. However in current applications, a progress bar is not updated, leading to inaccuracies. The opposite process (e.g., skipping pages) occurs during forward space operations, also resulting in progress bar inaccuracies.

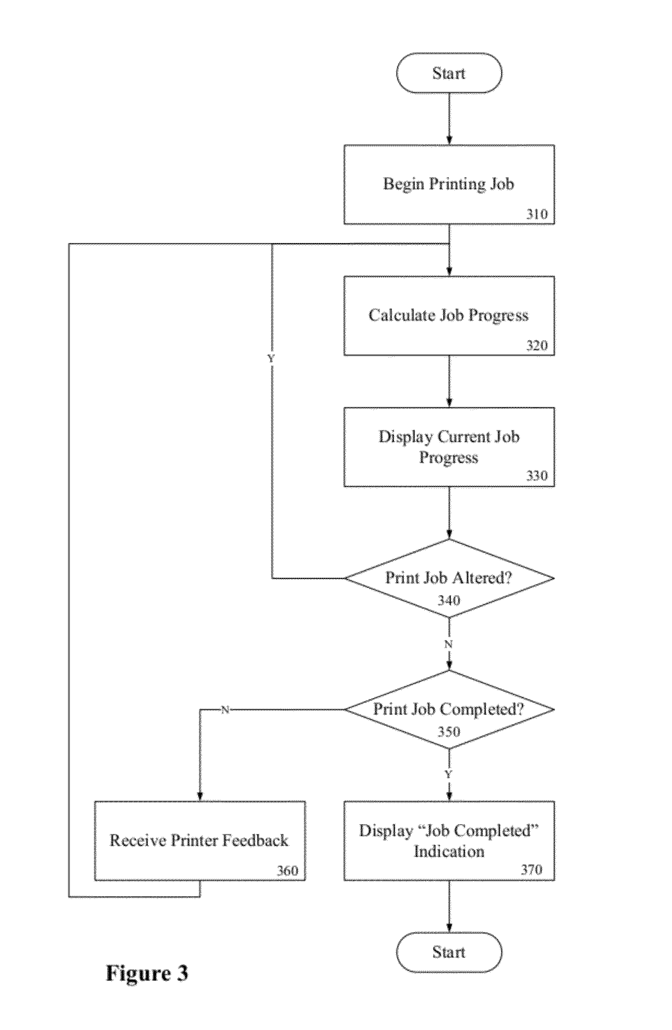

According to one embodiment, a printing software product is provided that presents an accurate progress bars that takes into account backspace or forward space operations that have been performed on a print job. FIG. 3 is a flow diagram illustrating one embodiment for providing a print job progress bar. At processing block 310, the printing of a print job at a printer 109 is initiated.

At processing block 320, the printing software product calculates the print progress of the job once the job begins printing. In one embodiment, the printing software product calculates the print progress based on the size of the print job (e.g., number of pages) and the print speed of printer 109. At processing block 330, the print job progress is displayed in GUI 100 using progress bar 230 and the corresponding completed percentage. At decision block 340, the printing software product determines whether the print job has been altered by a spacing operation while printing. In one embodiment, the printing software product recognizes whenever an operator performs a backspace or forward space operation on the print and uses this information to update the print progress.

As a result, control is returned to processing block 320 for a recalculation of the print job progress if the printing software product detects that the print job has been altered. This time the calculation includes the page to which the print job has been reset (e.g., moved forward or backward), in addition to calculations based on the number of pages remaining to be printed. Subsequently, the updated progress is displayed at processing block 330.

If at decision block 340, it is determined that the print job has not been altered, it is determined whether the print job has been completed, decision block 350. If the job has not completed, the printing software product retrieves a feedback message from printer 109 indicating the page currently being printed at printer 109, processing block 360. Subsequently, control is returned to processing block 320 for a recalculation of the print job progress using the feedback message.

If at decision block 350, it is determined that the print job has been completed, a “Job Completed” message is displayed at GUI. In one embodiment, the message is displayed in place of progress bar 230. However in other embodiments, the message is displayed adjacent to progress bar 230. According to one embodiment, the above process takes into account spacing during the printing of multiple copies of a print job while.

In such an embodiment, the job progress calculation performed at processing block 320 takes into account the number of copies, in addition to the number of pages. Thus, the printing software product uses knowledge of a number of pages in a job, number of copies, current copy printing, and pages skipped to again ensure that the position of the progress bar is accurate.

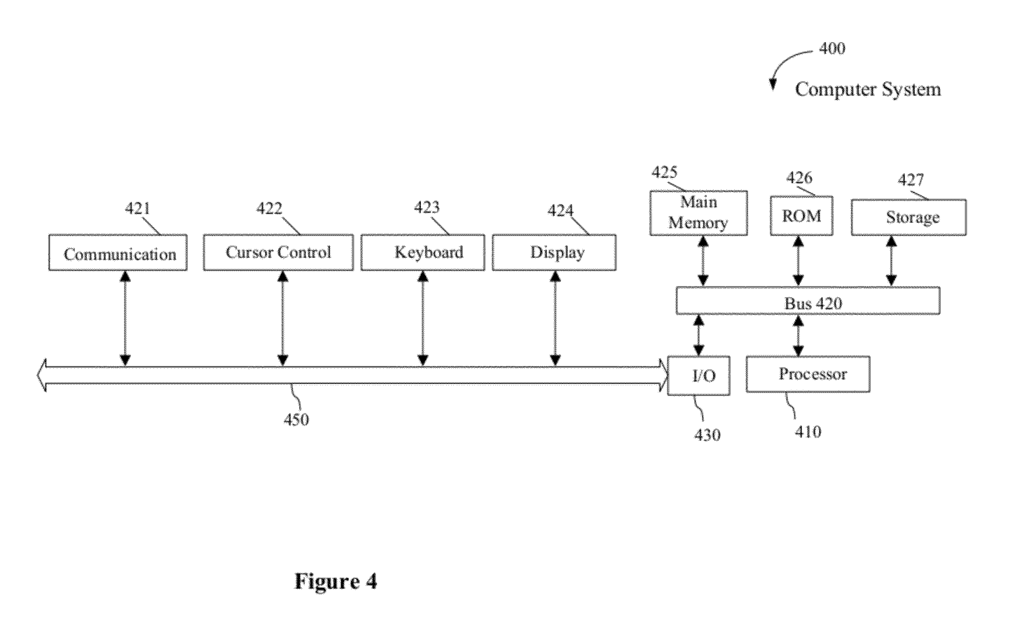

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer generated method comprising:
initiating the printing of a print job data at a printer;
displaying a graphics indication within a graphical user interface (GUI) of a printing progress of the print job while the print job is printing;
detecting that a spacing operation has been performed on the print job; and
updating the printing progress of the print job at the graphics indication based on the spacing operation that has been performed.

2. The method of claim 1 further comprising calculating the printing progress prior to displaying the graphics indication.

3. The method of claim 2 wherein the printing progress is calculated based on a size of the print job and a print speed of the printer.

4. The method of claim 1 further comprising recalculating the printing progress after detecting the spacing operation.

5. The method of claim 4 wherein the recalculation of the printing progress is calculated based on a page to which the print job has been reset by the spacing operation and a number of pages of the print job remaining to be printed.

6. The method of claim 1 further comprising receiving a feedback message from the printer after displaying the graphics indication.

7. The method of claim 6 further comprising recalculating the printing progress after receiving the feedback message.

8. The method of claim 7 wherein the recalculation of the printing progress is calculated based on a page of the print job currently being printed at the printer and a number of pages of the print job remaining to be printed.

9. The method of claim 1 further comprising:
detecting that the printing of the print job data at the printer has been completed; and
displaying a graphics indication within the GUI that the print job has been completed.

10. The method of claim 1 wherein the spacing operation is a backspace operation moving back to a page that has been previously printed.

11. The method of claim 1 wherein the spacing operation is a forward space operation skipping pages to be printed.

12. A print server, comprising:
a processor
a printing software product including a graphical user interface (GUI) to be executed by the processor to initiate the printing of a print job data at a printer, display a graphics indication within the GUI of a printing progress of the print job while the print job is printing, detect that a spacing operation has been performed on the print job and update the printing progress of the print job at the graphics indication based on the spacing operation that has been performed.

13. The print server of claim 12 wherein the printing software product calculates the printing progress prior to displaying the graphics indication.

14. The print server of claim 12 wherein the printing software product recalculates the printing progress after detecting the spacing operation.

15. The print server of claim 14 wherein the recalculation of the printing progress is calculated based on a page to which the print job has been reset by the spacing operation.

16. The print server of claim 12 further wherein the printing software product receives a feedback message from the printer indicating a page of the print job currently being printed after displaying the graphics indication and recalculates the printing progress after receiving the feedback message.

17. An article of manufacture comprising a machine-readable medium including data that, when accessed by a machine, cause the machine to perform operations comprising:
initiating the printing of a print job data at a printer;
displaying a graphics indication within a graphical user interface (GUI) of a printing progress of the print job while the print job is printing;
detecting that a spacing operation has been performed on the print job; and
updating the printing progress of the print job at the graphics indication based on the spacing operation that has been performed.

18. The article of manufacture of claim 17 comprising a machine-readable medium including data that, when accessed by a machine, further cause the machine to perform operations comprising calculating the printing progress prior to displaying the graphics indication.

19. The article of manufacture of claim 18 comprising a machine-readable medium including data that, when accessed by a machine, further cause the machine to perform operations comprising recalculating the printing progress after detecting the spacing operation.

20. The article of manufacture of claim 18 comprising a machine-readable medium including data that, when accessed by a machine, further cause the machine to perform operations comprising:
receiving a feedback message from the printer indicating a page of the print job currently being printed after displaying the graphics indication; and
recalculating the printing progress.
